(19) United States
(12) Patent Application Publication
(10) Pub. No.: US 2015/0032636 A1
(43) Pub. Date: Jan. 29, 2015

(54) Dissociative Payment Transaction And Receipt System And Methods Of Using Same

(71) Applicant: WCW Innovation, LLC, Spring Hill, KS (US)

(72) Inventors: Joshua Daniel Wedekind, Reno, NV (US); Clark H. Collier, Paola, KS (US)

(21) Appl. No.: 14/299,188

(22) Filed: Jun. 9, 2014

Related U.S. Application Data
(60) Provisional application No. 61/859,594, filed on Jul. 29, 2013.

(51) Int. Cl. G06Q 20/38

(52) U.S. Cl. CPC G06Q 20/3821
USPC 705/76

(57) ABSTRACT

A system for authorizing and facilitating payment transactions utilizing a payment device, a merchant terminal, and a payment server. The payment server generates unique, single-use payment credentials and provides the payment credentials to the payment device, which transfers the payment credentials to the merchant terminal. The merchant terminal submits the payment credentials and transaction request to the payment server, which facilitates the transfer of funds between the consumer and the merchant upon validation of the payment credentials. In an alternate use of the system, the payment device requests to open a running bill of charges with the merchant terminal. The payment device or the merchant terminal requests the payment server to close out the bill and finalize the charges. The payment server facilitates the transfer of funds between the consumer and the merchant. The payment server provides automated and manual accounting functions to both the consumer and merchant.

### CROSS-REFERENCE TO RELATED APPLICATIONS

This application claims the benefit of U.S. patent application Ser. No. 61/859,594 filed Jul. 29, 2013, the disclosure of which is incorporated herein by reference.

### BACKGROUND

For decades, banks, merchants, and consumers have employed various computer-based payment transaction systems to alleviate deficiencies associated with traditional cash or check transactions. A common example of these systems involves credit and debit card processing systems and methods.

In such a scenario, an account is opened by a consumer at an issuing institution, and typically a card or other payment device containing all the account information necessary to initiate a payment is issued to the purchaser by the issuing institution. The information on the card or other payment device is typically static and may only change with the issuance of a new card or similar payment device. Despite several advancements in fraud detection software, this system allows for millions of fraudulent transactions to occur every year. Though not appreciated in the prior art, an important deficiency in existing systems is that the exposed payment credentials are static and contained within a single payment device. These payment systems allow unscrupulous sales associates and malicious software processes to obtain payment credentials immediately before or after a legitimate transaction and retrieve all the payment credentials necessary to make fraudulent purchases.

Even integrated circuit payment devices such as those described in EMV specifications are not safe from compromised PIN terminals and other forms of fraud. Also, because the information contained in a card or other payment device is generally static, it allows malicious computer programmers to develop applications that guess valid payment credential information.

In addition, present methods of issuing transaction receipts are inefficient and rely too heavily on merchant and consumer processes. When a merchant fulfills the obligation to issue a transaction receipt, it is often printed on paper or emailed. In the case where a merchant manually issues paper receipts, there is potential for delivery failure, or for the paper receipt to be illegible, lost or be destroyed. In the event automated email receipts are sent, the receipt may not be readily located, or may be inadvertently deleted by the consumer. In both scenarios, there is often no method for the transaction receipt to be recovered by the consumer. Furthermore, many consumers need to retain and categorize receipts for tax and business purposes. The present systems for issuing and cataloging transaction receipts are inefficient at accommodating modern consumers.

### SUMMARY

The present invention broadly relates to systems and methods for instrumenting and performing a financial transaction and a related receipt service. In particular, systems and methods wherein payment account information is dissociated from payment credentials using a layer of abstraction to enhance security and reduce or eliminate the potential for fraudulent purchases are disclosed. A system for issuing, processing, and storing transaction receipts for use by consumers and merchants is also disclosed.

The Dissociative Payment Transaction and Receipt System (DPTRS) disclosed herein may eliminate the noted security vulnerability in the prior art by dissociating the payment account information from the payment credentials. This may be accomplished by generating unique Payment Authorization Credentials (PAC) for each transaction that are valid for only one transaction. The PAC may contain a large hash of random or pseudo-random alphanumeric and non-alphanumeric characters in order to make guessing the PAC virtually impossible. In addition, should an unscrupulous merchant employee or malicious software process copy the PAC, they would not be able to complete fraudulent transactions using the stolen PAC because each PAC is valid for a single use. As an added service, the DPTRS will be capable of issuing, processing, and storing transaction receipts on behalf of merchants and consumers.

### BRIEF DESCRIPTION OF THE DRAWINGS

FIG. 1 is a schematic diagram of an embodiment of the system of the dissociative payment transaction and receipt system.

FIG. 2 is a schematic diagram of an embodiment of the system of the dissociative payment transaction and receipt system.

FIG. 3 is a diagram of a placard used in an embodiment of the dissociative payment transaction and receipt system.

FIG. 4 is a schematic diagram of an embodiment of the system of the dissociative payment transaction and receipt system.

### DETAILED DESCRIPTION

The DPTRS is a system for authorizing and clearing financial transactions between various parties. Those parties include (i) a consumer, which may be a purchaser, who desires to participate in payment transactions and is the source of payment funds, (ii) an issuing institution, such as a bank, that offers accounts to consumers to use in payment transactions, (iii) a merchant, who may be selling a good or service, but is always the final recipient of payment funds in the payment transaction, and (iv) an acquiring institution, such as a bank, that offers accounts to merchants to use in payment transactions. An issuing institution may also act as an acquiring institution. Similarly, in some transactions a party may act as a merchant, while in other transactions the same party may act as a consumer.

Various embodiments of the system and methods of the DPTRS may be utilized, and two exemplary embodiments are described and depicted herein, the “Single Transaction” process of using the DPTRS, and the “Active Tab” process of using the DPTRS.

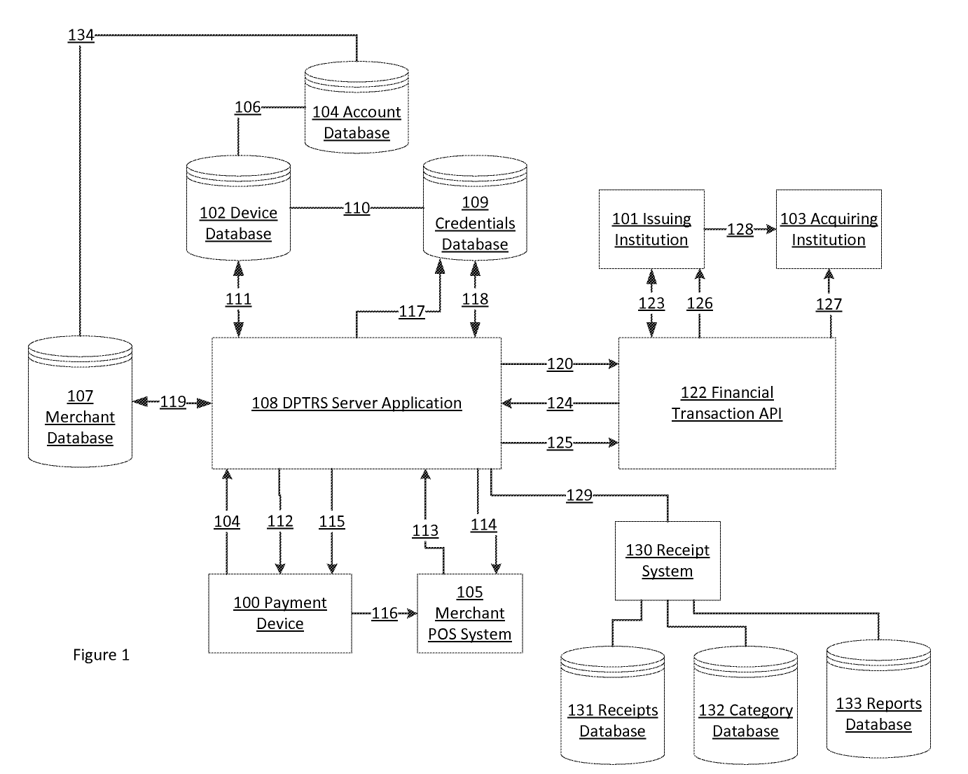

Referring to FIG. 1, a schematic diagram of the Single Transaction process of the DPTRS is depicted. In an embodiment of the DPTRS, a consumer opens an account with an issuing institution 101 compatible with the DPTRS. The consumer then installs the DPTRS software onto a payment device 100, if the software is not already available on the device. Examples of payment devices 100 include smartphones, laptops, tablet and desktop computers and other similar devices. The consumer registers the payment device 100 to an account held by the consumer at the issuing institution 101. This registration may be performed using an authenticated website interface or other secure means provided by the operator of the DPTRS, which may be one of the parties to the transaction or a third party.

The DPTRS is provided with a payment server application 108 for receiving, processing and responding to requests from the consumers and merchants, sometimes referred to herein as the DPTRS server 108. The DPTRS server 108 stores a record of the consumer's device 100 in device database 102, and a record of the account with the issuing institution in the account database 104. The record in database 102 for a consumer's device 100 is linked to the record in account database 104 for that consumer's account with the issuing institution 101 via relational link 106. In some embodiments, the relational link comprises an account identification number stored in both the device database 102 and the account database 104 to identify the account related to a payment device 100. After installation of the DPTRS software and registration to an account with an issuing institution 101, the payment device 100 contains an encrypted, shared secret referred to as an Access Token. The DPTRS server 108 also has access to a copy of the shared secret in device database 102.

Similarly, a merchant opens an account with an acquiring institution 103 compatible with DPTRS. The merchant then procures a compatible point of sale (POS) device 105, sometimes referred to herein as the merchant terminal 105. The merchant terminal 105 may be a dedicated device, preloaded with DPTRS-compatible software, or it may be a smartphone, laptop, tablet and desktop computer or other similar devices. The merchant registers the merchant terminal 105 to the account at the acquiring institution 103 in a similar manner to the consumer registering the payment device 100. After the installation of software and registration, the merchant terminal 105 contains DPTRS-compatible software, is registered to an account with an acquiring institution 103, and holds credentials issued to the merchant by DPTRS server 108 similar to the Access Token held by the consumer. The DPTRS server 108 stores a record of the merchant terminal 105 in merchant database 107, and also a record of the merchant's account with the acquiring institution 103 in a separate database. The merchant's account record may be stored in account database 104 and related to the merchant record in merchant database 107 via relational link 134. Merchant users may link more than one merchant POS device 105 with a single account record.

When a consumer desires to initiate a payment transaction with a merchant, and both parties possess DPTRS-compatible payment device 100 or merchant terminal 105, there are two primary methods which may be utilized to affect the payment. The two methods are referred to as Single Transaction and Active Tab payment transactions.

In FIG. 1, an embodiment of the Single Transaction process is depicted. Payment device 100 is used by a consumer to initiate the payment transaction through the interface on the payment device 100 with the DPTRS-compatible software installed on the payment device 100. Upon consumer initiation, the payment device 100 submits request 104 for a PAC from the DPTRS server 108 over a secure connection (such as SSL over the internet or otherwise) and sends the Access Token acquired during initial registration. In some embodiments of the system, the payment device 100 may also provide additional information in the transaction initiation request 104 besides the Access Token. For example, the transaction initiation request 104 may contain a device identification number, the date and time of the request, and a code identifying the request type such as PAC for a Payment Authorization Credentials request, among other possible data elements that may be provided to DPTRS server 108.

In this embodiment, the DPTRS server 108 validates the activation status of payment device 100 and the validity of the Access Token by comparing the information received in request 104 to information stored in the device database 102 via query 111 utilizing the Access Token. If the Access Token received from payment device 100 matches the shared secret stored in device database 102, DPRTS server 108 generates a PAC key code and an expiration time set to a desired interval in the future. The expiration time may be in a variety of formats, but in one embodiment is a DateTime object. In an embodiment of the system, the PAC key code comprises a large, random or pseudo-random character sequence.

The PAC key code, the expiration time, and the payment device identification number comprise the PAC. In some embodiments of the system, they are stored as a single data object, and are stored in the credentials database 109 via operation 117. The operation 117 may comprise an INSERT statement executed by a database server, or appending information to a flat file, or other similar operation depending on the type of database 109 used in the system. In an embodiment of the system, the PAC may comprise a system-generated PAC identification number, the PAC key code, the expiration time, and the device identification number for payment device 100. The static account information in account database 104 is therefore not directly associated with the PAC, but can be associated with the PAC by DPTRS server 108 using the link 106 in conjunction with the link 110.

Each PAC object stored as a record in credentials database 109 is symbolically linked to a payment device record in device database 102 by link 110 which may comprise a device identification number. The record for each PAC object in credentials database 109 may also include an additional status field. In some embodiments, the status field may have the following values: “active”, “inactive”, “tab”, “used”, “failed”, or “recurring”, and the initial status of a PAC record may be set to “active”.

In some embodiments, the PAC record in the credentials database 109 may include additional fields, such as merchant identification number, “time used” timestamp representing the date and time the transaction occurred, the amount of the transaction, and a description of the transaction which may include formatted details of the transaction, among others. These additional fields may not have an initial value and may be “null” in the PAC record as initially stored in credentials database 109. In various embodiments, they may be stored in the same or a different table or database as the other fields of the PAC record.

After the PAC record is stored in credentials database 109, DPTRS server 108 sends the generated PAC to the payment device 100 via response 112 over the secure connection such as an encrypted internet connection. If an error occurs during any of the steps necessary to generate and store the PAC, response 112 may contain an appropriate error message.

Once received from the DPTRS server 108, the payment device 100 then transfers the PAC to the merchant terminal 105 via transfer 116. This may be accomplished through a variety of methods, such as by generating a standard or multi-dimensional barcode on the screen of the payment device 100 to be scanned by the merchant terminal 105, or using wireless technologies to transmit the PAC from the payment device 100 to the merchant terminal 105, such as but not limited to WiFi, WiFi Direct, NFC, Bluetooth, Bluetooth Low Energy, and LTE.

Once the merchant terminal 105 has received the PAC, the merchant terminal 105 queries the DPTRS server 108 via a transaction request 113 over a secure connection (such SSL over the internet, or otherwise) and sends the PAC as well as the merchant's own credentials and detailed transaction information as parameters. In embodiments, the transaction request 113 may include, in addition to the PAC, a merchant identification number, the merchant credentials, and transaction information such as the amount of the transaction, the date, and any additional details or notes related to the transaction.

Upon receipt of a transaction request 113, the DPTRS server 108 verifies the PAC and merchant credentials. In one embodiment of the system, the DPTRS server 108 issues query 119 to merchant database 107 to retrieve the merchant credentials to match those provided in the transaction request 113. If the merchant credentials are validated, then the DPTRS server 108 validates the PAC received in transaction request 113.

In an embodiment of the system, DPTRS server 108 queries credentials database 109 via query 118 for a PAC record matching that received from the merchant terminal 105. In some embodiments, the DPTRS server 108 submits query 118 to credentials database 109 to retrieve a PAC record with a PAC identification number matching the information received in the transaction request 113, and compares the PAC key code and other fields with those received in the transaction request 113.

The DPTRS server 108 may perform additional data verifications. In one additional data verification, DPTRS server 108 confirms that the status of the PAC is “active” before continuing with the transaction. If the status is not “active”, then an error message is returned to the merchant and the transaction is terminated. In another additional data verification, the expiration time is compared to the current time; and if the expiration time has not yet passed, the status is updated to “used” and the transaction continues; otherwise the status is updated to “inactive” and the transaction is terminated. Other additional data verifications and manipulations may also be performed at this time as appropriate.

After executing any additional data verifications or modifications, if the transaction is to continue, then merchant and transaction information is inserted into the record for the PAC in the credentials database 109. This may comprise updating the existing record in the credentials database 109 or inserting a new record in a separate table or database relationally linked to credentials database 109. If the transaction is a recurring transaction, a separate table may also be queried for restrictions or rules regarding the recurring transaction.

If all validations and verifications are successful, DPTRS server 108 retrieves purchaser and merchant account information necessary to facilitate the financial transaction between the issuing institution 101 and the acquiring institution 103 from account database 104. Then, DPTRS server 108 sends request 120 through financial transaction API 122 to verify that sufficient funds are available with the purchaser's issuing institution 101. The financial transaction API 122 may submit query 123 to issuing institution 101 to determine the sufficiency of available funds. This process may be conducted over existing core banking software systems, existing interfaces to bank systems, other existing financial transaction solutions, or newly designed and developed financial transaction solutions. The result is returned to DPTRS server 108 in response 124.

If sufficient funds are available, DPTRS server 108 facilitates the transaction; otherwise it responds to the merchant POS system with an appropriate error message. Facilitating the transaction may include updating the status of the PAC to “used” or “inactive”, and moving the PAC and purchase information into a historical table within the database system. The DPTRS server 108 also communicates with the issuing and acquiring institutions, 101 and 103 respectively, to ensure a transfer of funds is completed.

In an embodiment of the system, the communication with the issuing and acquiring institutions comprises request 125 sent through the financial transaction API 122 for the transfer of funds in the transaction amount from the consumer's account with the issuing institution 101 to the merchant's account with the acquiring institution 103. In the depicted embodiment, financial transaction API 122 coordinates the transfer of funds 128 by sending requests 126 and 127 to the issuing institution 101 and the acquiring institution 103. In other embodiments of the system, this process may involve a clearing process that occurs on a recurring schedule and which may involve other financial institutions in addition to the issuing and acquiring institutions, or other methods of coordinating the transfer of funds.

The DPTRS server 108 may also submit the transaction details via request 129 to the receipt system 130. The transaction details may then be processed by receipt system 130 and stored as appropriate in receipts database 131, category database 132, and reports database 133.

Finally, an appropriate response 114 is sent to the merchant terminal 105 over the secure connection. If an error occurred during processing, an appropriate error message is sent. If the transaction was successfully processed, then a transaction confirmation is sent in response 114. A transaction receipt may also be sent to the payment device 100 via connection 115. The receipts sent to both the merchant terminal 105 and the payment device 100 are stored by DPTRS server 108 and may be made available to a consumer or a merchant via registered devices or secure interfaces such as authenticated web interfaces.

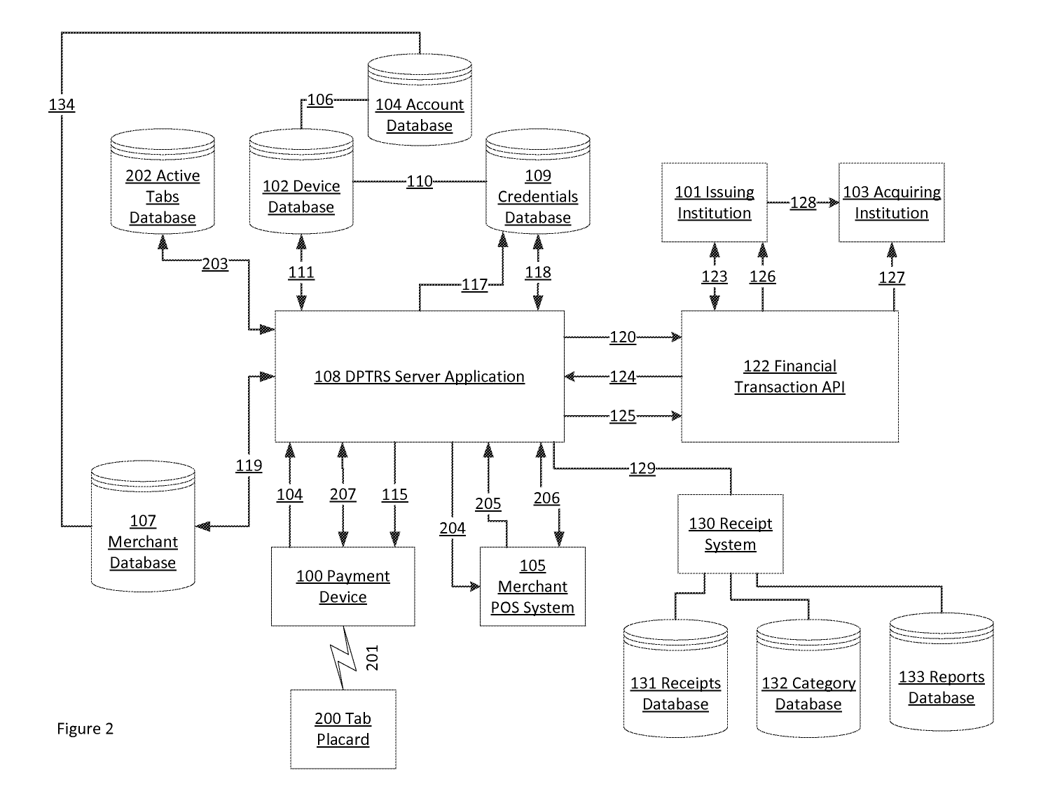

Referring now to FIG. 2, the Active Tab process of using the system is depicted in schematic view. The Active Tab process for executing a payment transaction is similar to the Single Transaction process with respect to security; payment credentials are generated in real time and are valid for only a single transaction. However, the method for initiating the transaction is quite different. The Active Tab method is most suited for restaurant, bar, and gas station pump settings, but may be used in other environments.

The Active Tab process allows a consumer to open an electronic tab and keep it open for an undetermined amount of time and number of purchases, before closing the tab and paying for the aggregate sum of the purchases. In some embodiments of the system, a consumer and a merchant may be required to have completed the registration steps described in relation to FIG. 1 prior to utilizing the Active Tab process.

In this system, payment device 100 is a client device previously registered with the DPTRS server 108. Payment device 100 contains an Access Token obtained during registration that is stored in device database 102 along with an account identification number, which relationally links the payment device 100 to the corresponding account stored in account database 104 via relational link 106. Merchant terminal 105 is a POS device using DPTRS software. Merchant terminal 105 contains credentials obtained during registration that are stored in merchant database 107 with an account identification number, which relationally links the merchant terminal 105 to the corresponding merchant account stored in account database 104 via relation link 134.

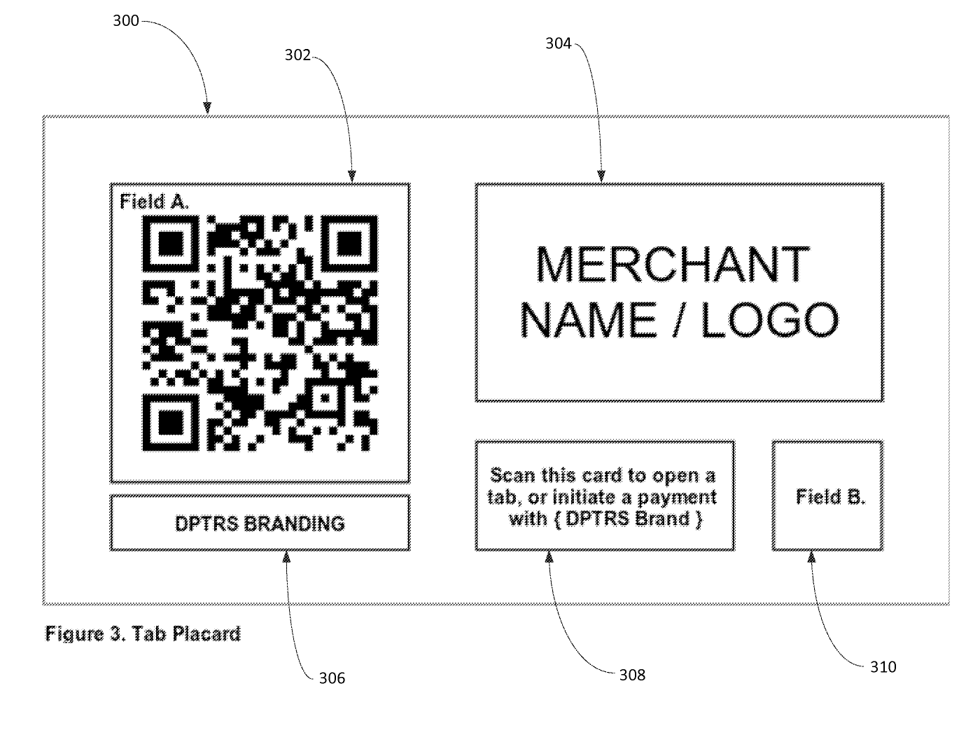

When a consumer decides to initiate an Active Tab transaction, the payment device 100 is used to obtain merchant information. This information may be identified using a variety of means, such as a website or other electronic means, or it could be by scanning a barcode or multi-dimensional barcode encoding the merchant information displayed on a placard 200 such as that described in relation to FIG. 3. The placard may be a physical device placed at a restaurant table, bar counter, gas station pump, or any location to be associated with a bill of charges. The merchant information may also be received via wireless technologies 201 such as but not limited to WiFi, WiFi Direct, NFC, Bluetooth, Bluetooth Low Energy, and LTE, which may also be provided as a part of the placard described in relation to FIG. 3. Merchant information may also be identified by entering merchant information into payment device 100 manually or via images and character recognition, or other similar means.

DPTRS software on payment device 100 recognizes the valid merchant payment information. Once the payment device 100 has merchant information, a request 104 is sent by the payment device 100 providing its Access Token, the merchant information and a request to open a new tab (create a bill of multiple charges). In an embodiment, the request 104 may include a device identification number for the payment device 100, the Access Token for the consumer, a timestamp, and request detail information. The request detail information may, in embodiments, include a merchant identification number, a tab identification number, and a tab key token.

Similarly to the process described in relation to FIG. 1, the DPTRS server 108 validates the Access Token and verifies the merchant information in request 104 and retrieves any additional merchant information, such as connection information for the merchant terminal 105. If all validations are successful, DPTRS server 108 creates a PAC as described in relation to FIG. 1 and stores it in the credentials database 109, and sets the PAC record to an “active” or “tab” status. Additionally, DPTRS server 108 creates a database record for the tab in active tabs database 202 via query 203 to store the bill of charges for the consumer. In some embodiments of the system, the records in the active tabs database 202 contain at least the following information: a system-generated tab identification number, a device identification number linking the tab record to the record in device database 102 for a payment device 100, a merchant identification number linking the tab record to the record in the merchant database 107 for a merchant terminal 105, a tab identification number for uniquely identifying the tab, a PAC identification number linking the tab record to the record in the credentials database 109 for the PAC generated for this transaction, and a bill containing formatted lists of items added to the bill of charges. In other embodiments of the system, the bill details and other information related to the tab may be stored in other tables relationally linked to the active tabs database 202.

Once the new tab record is created, DPTRS server 108 sends a request 204 to the merchant to open a new bill of charges for the Active Tab transaction. The request 204 will cause the merchant terminal 105 software to prompt a merchant user or process to create a running tab of charges for the consumer associated with the request 204. This prompt may contain pertinent information such as the name of the consumer.

If the merchant user rejects the request, the tab record is removed from the active tabs database 202, and the consumer will receive notification from payment device 100. The merchant terminal 105 sends response 205 to the DPTRS server 108 indicating acceptance or rejection of the Active Tab transaction request. If the transaction is accepted, the response may contain the merchant credentials for verification by DPTRS server 108.

The DPTRS server 108 validates the merchant credentials received in response 205 against the information stored in merchant database 107. If the merchant credentials are valid, a stateful connection 206 is established between DPTRS server 108 and merchant terminal 105 to allow the merchant to add charges to the tab and communicate those charges to the DPTRS server 108. As such charges are sent to DPTRS server 108, the relevant records in the active tabs database 202 are updated or additional records are inserted as necessary. DPTRS server 108 may, in some embodiments, regularly poll the merchant device 105 for updates to the bill of charges.

A stateful connection 207 is also established between DPTRS server 108 and payment device 100. As the merchant adds charges to the active tabs database 202, the DPTRS server 108 pushes those charges to the payment device 100 through connection 207. At any time, the consumer may use the payment device 100 to send a payment request through connection 207 and close out the tab. The merchant may also initiate closing out the tab through merchant terminal 105.

The payment request may include the PAC for payment device 100, and the list of updated and authorized tab charges on the payment device 100. DPTRS server 108 validates the PAC as described above, and compares the payment device list of tab charges to the active tabs database 202. Any discrepancy in the list of tab charges will prompt a request for authorization from the payment device 100 for the most recent list of tab charges.

Upon receipt of a payment request and reconciliation of any discrepancies, the DPTRS server 108 checks with the consumer's issuing institution to verify sufficient funds are available, and, if so, facilitates the clearing of the transaction in a similar manner to that described in relation to FIG. 1 except the PAC, transaction amount, and transaction details are retrieved from the tab record, and the merchant is previously authenticated. Facilitating the clearing of the transaction includes marking the PAC as being “used” in the credentials database 109 and, optionally, placing the PAC and tab records into historical tables. The DPTRS server 108 then communicates with the issuing and acquiring institutions to ensure a transfer of funds is completed. Finally, an appropriate response is sent to the merchant terminal 105 over a secure connection. A receipt 115 is sent to the payment device 100 via a secure connection.

If the transaction commits successfully, a transaction confirmation is sent to merchant terminal 105. In the event an error occurs during any authorization or transaction process, an appropriate error message is returned to merchant terminal 105.

A transaction receipt is pushed 115 to payment device 100 with information about the transaction. The DPTRS will securely store these electronic receipts and allow access via registered payment devices and authenticated web interfaces.

In an additional embodiment of the system using the Active Tab process, an open application programming interface, or API, is available and allows merchants to create a menu of items for sale that can be pushed to payment device 100 upon creation of a new tab. The consumer would then have the option to order items off the menu directly from their payment device 100. In such an embodiment, the DPTRS server 108 receives additional charges from payment device 100, updates the active tabs database 202 as described above, and then pushes the additional charges to the merchant terminal 105.

Referring now to FIG. 3, an example of a placard is described in detail. Placard 300 is a physical device containing encoded information. In this example placard, area 302 contains the merchant payment information encoded in a multi-dimensional barcode to be scanned by the purchaser's payment device. The merchant payment information encoded in placard 300 is a formatted data object unique to each placard. An example of the merchant payment information encoded on the placard in one embodiment of the system includes a merchant identification number, a tab identification number, and a generated token representing a tab key value.

The placard may optionally contain merchant branding, DPTRS branding, and instructions for use in areas 304, 306, or 308. On the depicted placard 300, area 304 is shown for merchant branding, area 306 for DPTRS branding, and area 308 for instructional information; however, in other versions of the placard 300 those areas may be arranged differently or may be removed from the placard 300.

Placard 300 may also optionally include area 310 that is reserved for attaching or integrating a wireless transmitter. This transmitter may use NFC or Bluetooth Low Energy, but may use a variety of other wireless technologies. The wireless transmitter disposed on area 310 device may be designed to emit a wireless signal containing the encoded merchant payment information for receipt by the purchaser's payment device.

Alternatively, placard 300 can be replaced by a computer-based process. The merchant payment information can be obtained by payment device 100 through a website interface, digital message, or other electronic means.

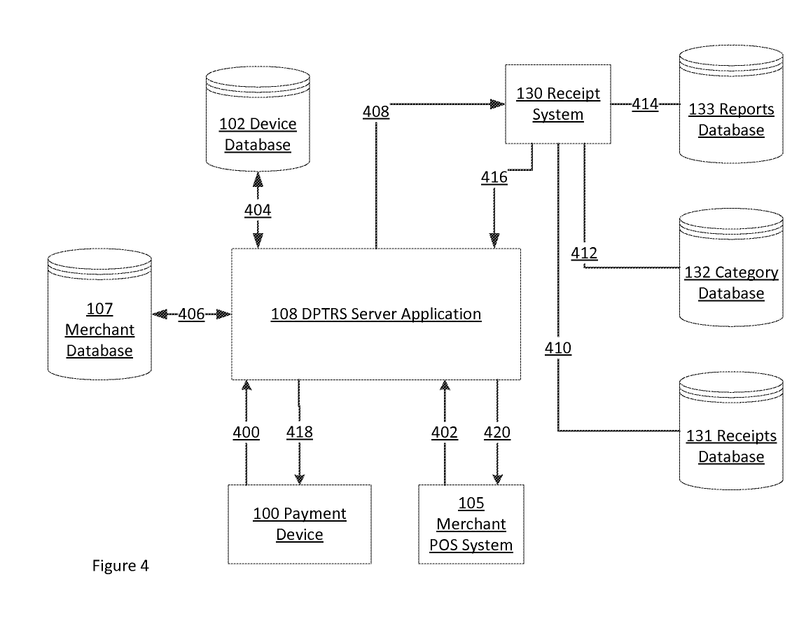

Referring now to FIG. 4, in some embodiments of the system, a receipt tracking service is also provided for accessing previous transaction data. For personal and business or nonprofit consumers, the traditional methods of handling transaction receipts and associated accounting; whether for proper financial oversight, expense accounts, or legal compliance etc.; are cumbersome, time-consuming, inefficient, frustrating, and prone to inaccuracies. The receipt tracking system disclosed herein provides users and their employers with electronic transaction receipts as well as the ability to specifically account for these expenditures by pre-assigning appropriate categories, or real-time assigning of categories, or user-defined timeframe of assigning categories that are then automatically transferred to their accounting or financial software either directly or in a pending status.

In this embodiment of the receipt system, payment device 100 is a client device previously registered with the DPTRS server 108. Payment device 100 contains a shared secret obtained during registration that is stored in device database 102 along with an account identification number. Merchant terminal 105 is a POS device using DPTRS software. Merchant terminal 105 contains merchant credentials obtained during registration that are stored in merchant database 107.

The receipt service process is capable of handling requests from both consumers and their employers where appropriate, and merchants. The method of execution is largely the same in both cases. In either case, a DPTRS user selects a receipt action to perform from their client device interface. Examples of valid client devices include registered payment devices, registered merchant POS systems, and authenticated web services.

For a consumer or their employer, payment device 100 (or the authenticated web interface or other client device) sends a receipt action request 400 to DPTRS server 108 via a secure connection such as an encrypted internet connection. For an employer managing the expenses of its employees, a single interface via application interface may allow a single user to manage the expenses of a plurality of payment devices. In some embodiments, the receipt system may include security and authorization mechanisms to control which users have the access and authority to view and modify receipts and their assigned categories and to execute other functions of DPTRS or the receipt tracking system components of DPTRS. In some embodiments, the receipt tracking system may directly interface with accounting or financial software, or may provide a transaction file for uploading to such software packages.

The request 400 contains formatted parameters identifying the device and the request type. In some embodiments of the system, the receipt action request object includes a device identification number identifying the payment device 100, payment access credentials for the consumer or merchant comprising a shared secret, a timestamp, and receipt request details. The receipt request details may include a desired action and parameters appropriate for the desired action. In some embodiments, the receipt requests supported by DPTRS server 108 include retrieving a list of receipts, retrieving a list of receipts meeting specified criteria such as date range or other limitation, retrieving detailed receipt information for a specific receipt, categorizing a receipt, retrieving receipts by category, saving user defined receipt reports, and executing user defined receipt reports and retrieving the output.

An example receipt request comprises a request for a list of receipts within a certain range of transaction dates. In an embodiment of the system, such a request may contain the following action and parameter information. The “action” code for the list may be of a text string, number or other identifier used to identify the desired action. In this example, the “action” code for a list of transactions within a date range is the text string “listByDate”. This action may identify to DPTRS server 108 that it should receive additional parameters such as the starting date of the date range potentially identified as the “startdate” parameter, the ending date of the date range potentially identified as the “enddate” parameter, and other optional parameters such as an “order” parameter that may indicate the ordering of the results returned by the server such as order by transaction date in ascending or descending order. In this example, a list of receipts is being requested for a specified range of dates. The list should be ordered by descending date and time. Merchant terminal 105 is capable of making a similar request 402 using merchant credentials instead of payment device credentials. DPTRS server 108 submits query 404 or 406 to the device database 102 or the merchant database 107 for a request initiated by payment device 100 or merchant terminal 105, respectively. If the requestor credentials are successfully validated, the receipt action request is passed by request 408 to the receipt system 130 along with the account identification number.

Receipt system 130 may determine that the requesting user has sufficient privileges to receive the requested information. Receipt system 130 queries the receipts database 131, category database 132, and reports database 133 via 410, 412, and 414 respectively as needed to perform the request. The response output is formatted by the receipt system 130 and returned to DPTRS server 108 by response 416. DPTRS server 108 pushes the formatted response to the original requesting client via connections 418 or 420. The client software parses the formatted response and displays the results. In other embodiments, the receipt may be delivered via email or other methods for electronic delivery of information.

Whenever secure communications or connections are referred to herein, various technologies may be used to provide such secure connections as are currently known or may be developed in the future. For example, all communications completed over a secure connection such as an encrypted internet connection may also be further encrypted using a shared secret algorithm unique to each account. Similarly, various communications described as separate connections herein may comprise multiple data transfers between the two parties via a single persistent connection.

Generally, the embodiment of the system and methods depicted in the figures represent a set of devices and databases, and a system of processes for communication and interoperation of the devices and databases. The database items may either be unique, physical databases or merely logically distinct tables in one or more database systems. The secure connections described in relation to the figures indicate a one-way transfer of data over a network, either internal or external, or by other physical means such as encoding and scanning a barcode. The queries comprise requests for data conducted over a network, either internal or external, whereby parameters are passed in a request to a database system, such as one using structured query language (or SQL), and data is either inserted into a database system, or data is retrieved from a database system in the form of a result set containing one or more rows of data. The relational links indicate a logical link between two database items or records in a database, and are shown to portray important relationships between the logical entities stored within the database system.

Many different arrangements are possible without departing from the spirit and scope of the present invention. Embodiments of the present invention are described herein with the intent to be illustrative rather than restrictive. Alternative embodiments will become apparent to those skilled in the art that do not depart from its scope. A skilled artisan may develop alternative means of implementing the disclosed improvements without departing from the scope of the present invention. Further, it will be understood that certain features and subcombinations are of utility and may be employed without reference to other features and subcombinations and are contemplated within the scope of the invention. The description should not be restricted to the specific described embodiments.

What is claimed is:

1. A method for facilitating a secure payment transaction using a payment device, a merchant terminal and a payment server, said method comprising the following steps:
submitting a request for payment credentials from the payment device to the payment server including a shared secret;
verifying the shared secret received from the payment device;
generating the payment credentials requested by the payment device;
providing the payment credentials to the payment device;
transferring the payment credentials from the payment device to the merchant terminal;
submitting a request from the merchant terminal to the payment server including a shared secret, the payment credentials, and transaction information;
verifying the shared secret received from the merchant terminal;
validating the payment credentials received from the merchant terminal;
invalidating the payment credentials to prevent reuse of the payment credentials; and
facilitating the transfer of funds between an account associated with the payment device to an account associated with the merchant terminal.

2. The method of claim 1 wherein the step of invalidating the payment credentials comprises marking the payment credentials as used on the payment server.

3. The method of claim 1 wherein the step of generating the payment credentials comprises utilizing a random or pseudo-random hash algorithm to dynamically generate a unique transaction identifier.

4. The method of claim 3 further comprising the step of assigning an expiration timestamp to the payment credentials upon generation.

5. The method of claim 1 wherein the step of invalidating the payment credentials is performed without regard to whether the prior steps in the process are completed successfully.

6. The method of claim 1 wherein the step of transferring the payment credentials comprises the steps of:
generating a barcode on the payment device containing an encoded version of the payment credentials; and
scanning the barcode using a barcode reader attached to the merchant terminal.

7. The method of claim 1 wherein the step of transferring the payment credentials comprises the steps of:
establishing a wireless connection between the payment device and the merchant terminal; and
transmitting the payment credentials over the wireless connection.

8. The method of claim 1 wherein the step of generating the payment credentials is executed only if the step of verifying the shared secret from the payment device is successful.

9. The method of claim 8 wherein the step of facilitating the transfer of funds is executed only if the step of validating the payment credentials is successful.

10. The method of claim 9 wherein the step of invalidating the payment credentials is always performed if the step of submitting a request is performed, even if the steps of verifying the shared secret received from the merchant terminal and of validating the payment credentials are unsuccessful.

11. The method of claim 1 further comprising the steps of:
generating a receipt containing transaction information; and
providing the receipt to the payment device.

12. The method of claim 11 further comprising the step of providing an interface for querying, updating, categorizing and downloading at least one receipt generated for the payment device.

13. The method of claim 11 further comprising the steps of:
assigning a category to the receipt;
storing the receipt in a receipt database;
providing an interface for querying the receipt database.

14. The method of claim 13 wherein the step of assigning a category to the receipt comprises automatically assigning a category to the receipt based on the transaction information.

15. The method of claim 13 wherein the step of assigning a category to the receipt comprises receiving a category for the receipt selected by a user of the payment device.

16. The method of claim 13 wherein the step of providing an interface for querying the receipt database comprises the steps of:
facilitating a user to define a report including transaction information contained in the receipt;
executing the report upon the request of a user; and
retrieving the output of the report for a user.

17. The method of claim 12 wherein the interface is provided via a web application, a mobile device application, or a computer application.

18. A method for facilitating a secure payment transaction using a payment device, a merchant terminal and a payment server, said method comprising the following steps:
receiving merchant payment information using the payment device;
submitting a request for payment credentials from the payment device to the server application using the merchant payment information and a shared secret;
generating payment credentials requested by the payment device;
creating a bill of charges on the payment server for the payment device;
establishing a connection between the merchant terminal and the payment server;
receiving updates to the bill of charges from the payment device or the merchant terminal;
providing updates to the bill of charges from the payment server to the payment device or the merchant terminal;
receiving at the payment server a request from the merchant terminal or the payment device to close the bill of charges and initiate payment;
invalidating the payment credentials to prevent reuse of the payment credentials; and
facilitating the transfer of funds between an account associated with the payment device to an account associated with the merchant terminal.

19. The method of claim 18 wherein the step of generating the payment credentials comprises utilizing a random or pseudo-random hash algorithm to dynamically generate a unique transaction identifier.

20. The method of claim 19 further comprising the step of assigning an expiration timestamp to the payment credentials upon generation.

21. The method of claim 18 wherein the payment credentials are deactivated after a payment request is received using said credentials, regardless of whether the transaction is successful.

22. The method of claim 18 wherein the step of facilitating the transfer of funds occurs only if both the payment device and the merchant terminal provide valid shared secrets to the payment server to authenticate their identity.

23. The method of claim 18 further comprising the steps of establishing a connection between the payment device and the payment server for exchanging updates to the bill of charges.
